(19) United States
(12) Patent Application Publication
(10) Pub. No.: US 2006/0149562 A1
(43) Pub. Date: Jul. 6, 2006

(54) Management system for business invenstment

(76) Inventor: Nobuo Oyama, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/541,356

(22) PCT Filed: Jan. 9, 2003
(86) PCT No.: PCT/JP03/00127

§ 371 Date: Mar. 6, 2006

(51) Int. Cl. G06Q 99/00; G06F 15/02; G06F 9/46

(52) U.S. Cl. 705/1; 705/9

(57) ABSTRACT

In a system for managing project investment according to the present invention, a trustee 3 is entrusted with components of the particular project by a project holder 1 having the particular project, an investor 2 invests in the particular project, and the trustee 3 performs investment recovery management using a computer system based on a dividend management program 33 agreed upon in advance between the project holder 1 and the investor 2.

### TECHNICAL FIELD

The present invention relates to a system for managing project investment, in particular, a system using a computer system for managing and operating investment specified in projects.

### BACKGROUND ART

Conventionally, a capital investment has been predominantly made in a company or the like having prospective technologies and projects, or producing promising products. The investment funds are entrusted to and managed by the investment destination such as a company.

However, such a company often owns plural projects simultaneously, so even if an investor focuses attention on a promising one of the projects, the investment must be made in the company as a whole. An effect that can be obtained by the capital investment made in the company, while focusing attention on a promising project, is dominated by an overall managing status of the company including all the other projects. Therefore, risk taking of the investment and return on the investment depend on management performance of the entire company. This forces the investor to judge not only details and prospects of project to which the investor pays attention but also a managing status and prospects of a company itself having such project. The judgment tends to be far beyond abilities of self-judgment of many investors.

It would be reasonable to consider that, the more outstandingly promising the project of interest is than other projects of the company, the less an effect obtained by the investment made in the project becomes due to the other projects.

### DISCLOSURE OF THE INVENTION

The present invention has been made in order to solve such problems and it is an object of the present invention to provide a system for managing project investment that can develop a particular promising project without being affected by a managing status of a project holder owning the project and can improve investment performance.

A system for managing project investment according to the present invention includes: a project holder that has a particular project; an investor that invests in the particular project; and a trustee that is entrusted with components of the particular project by the project holder and performs investment recovery management using a computer based on a dividend management program agreed upon in advance between the project holder and the investor.

The system according to the present invention may be configured such that in which the trustee investigates the components of the project entrusted by the project holder and notifies the investor of a result of the investigation, and the investor determines investment in the particular project based on the result of the investigation.

Also, the system according to the present invention may further include audit agency that audits progress of project by the project holder.

The system according to the present invention may be configured such that in which, when a payment request is sent from the project holder, the audit agency judges whether it is necessary to correct the payment request, and, when it is judged that it is necessary to correct the payment request, the trustee instructs the project holder to correct the payment request and, when it is judged that it is unnecessary to correct the payment request, the trustee executes payment to the project holder.

Also the system according to the present invention may also be configured such that in which, when payment is made to the trustee from the project holder, the audit agency judges whether a paid amount is appropriate in light of a state of progress of the project, and, when it is judged by the audit agency that the paid amount is not appropriate, the trustee performs investment recovery management in accordance with a predetermined first dividend management correction program.

Further, the system according to the present invention may be configured such that in which the audit agency judges whether it is possible to attain a target dividend amount in light of a state of progress of the project, and, when it is judged by the audit agency that it is impossible to attain the target dividend amount, the trustee extends a contract term of the investor and performs investment recovery management in accordance with a predetermined second dividend management correction program.

### BRIEF DESCRIPTION OF THE DRAWINGS

FIG. 1 is a block diagram showing a constitution of a system for managing project investment according to an embodiment of the present invention;

FIG. 2 is a flowchart showing processing at the time of an investment contract in the embodiment;

FIG. 3 is a flowchart showing a modified example of processing at the time of the investment contract;

FIG. 4 is a flowchart showing processing for a payment request by a project holder in the embodiment; and

FIG. 5 is a flowchart showing processing for investment recovery in the embodiment.

### BEST MODE FOR CARRYING OUT THE INVENTION

An embodiment of the present invention will be hereinafter explained on the basis of the accompanying drawings.

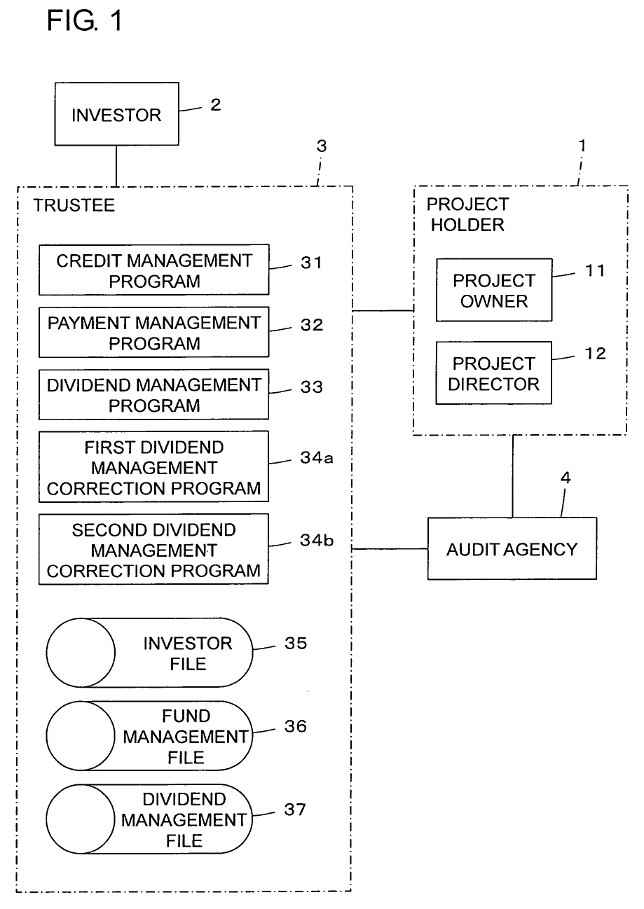

FIG. 1 shows a system for managing project investment according to the embodiment of the present invention. A particular project is owned by a project owner 11 and project activities are conducted by the project owner 11 or a project director 12 who is entrusted with the project activities by the project owner 11. The project owner 11 and the project director 12 are collectively referred to as a project holder 1. An investor 2 invests in a particular project of the project holder 1. A trustee 3 is present between the project holder 1 and the investor 2. The trustee 3 is entrusted with components of the particular project by the project holder 1 and performs management for investment recovery for the investment using a computer system (not shown) . The computer system is constituted to operate according to a credit management program 31, a payment management program 32, a dividend management program 33, and a first dividend management correction program 34a or a second dividend management correction program 34b. The computer system includes an investor file 35, a fund management file 36, and a dividend management file 37. An audit agency 4 for auditing progress of project by the project holder 1 is also provided.

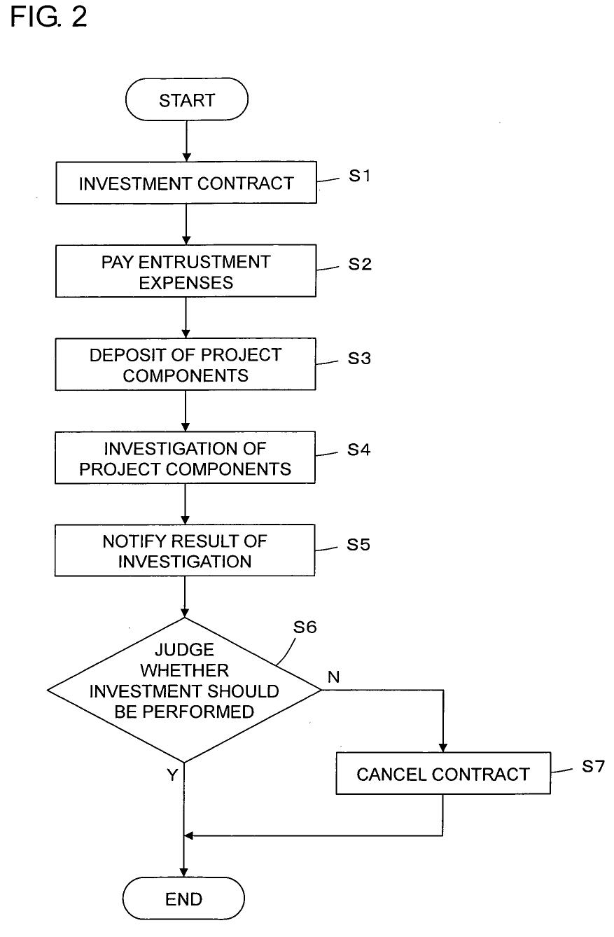

First, processing from concluding an investment contract to making an investment will be explained with reference to a flowchart in FIG. 2.

In step S1, the investor 2 and the project holder 1 conclude an investment contract for a particular project. The investment contract includes components of project and usable project assets or operating bases, a total amount of investment, investment amounts of respective investors in the case in which plural investors 2 are present, a method of collecting invested money and earnings, and a method of administrating the managing entrustment of project by the trustee 3. In other words, the investment contract clearly describes project management, a method of administrating the project management, and a termination period of the investment contract.

After the investor 2 and the project holder 1 pay entrustment expenses to the trustee 3 in step S2, in step S3, the project holder 1 deposits components of the project such as usable assets or operating bases such as a license of the project with the trustee 3. In step S4, the trustee 3 investigates the components of the project deposited. In step S5, the trustee 3 notifies the investor 2 of a result of the investigation.

In the following step S6, the investor 2 judges whether the investor 2 should invest in the project on the basis of the result of the investigation received from the trustee 3. In this case, the investment is to be made in the particular project and not in the project holder 1 itself. Therefore, the investor 2 can easily judge whether the investor 2 should make an investment. If the investor 2 invests in the project, the investment contract is materialized. On the other hand, if the investor 2 does not invest in the project, the processing proceeds to step S7 and the investment contract is cancelled.

Note that the project holder 1 can receive a contract deposit in the investment contract materialized by subscription to the investment. In this case, the investor 2 pays the remainder, which is calculated by subtracting this contract deposit from a contracted investment amount, to the trustee 3 directly. The project holder 1 pays the contract deposit to the trustee 3. These payments to the trustee 3 are managed by the credit management program 31 of the computer system. Names of investors, investment amounts of the investors, payment destinations of collected money, a payment method, a method of communication, and the like are recorded in the investor file 35 of the computer system in the trustee 3 and are also inputted to other program software of the computer system as required. The entire contribution collected under the trustee 3 is recorded in the fund management file 36.

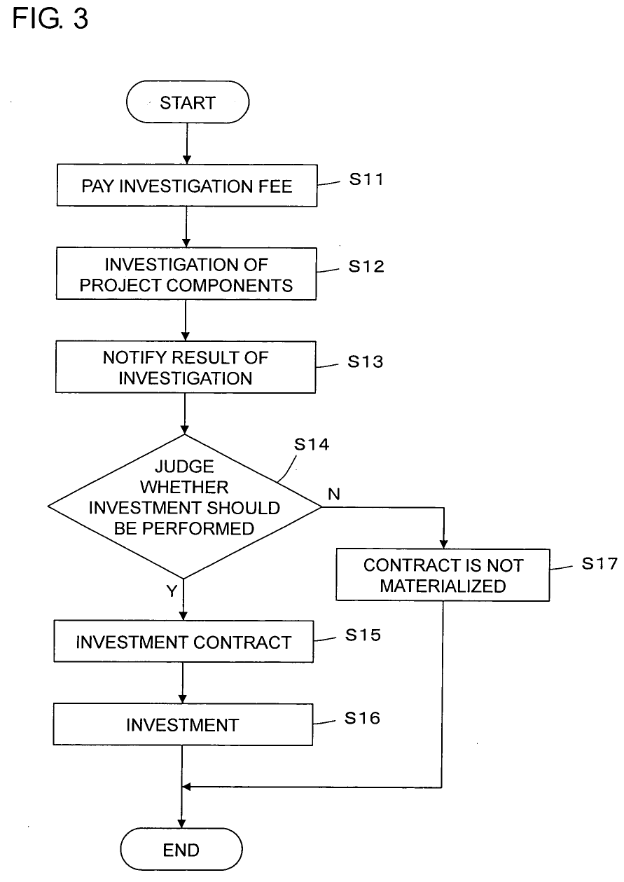

Note that it is possible to adopt a procedure shown in FIG. 3 instead of the procedure in FIG. 2 described above. First, in step S11, the project holder 1 submits components of project to the trustee 3 and pays an investigation fee to the trustee 3. In step S12, the trustee 3 investigates the components of the project. In step S13, the trustee 3 notifies a person desiring to invest in the project of a result of the investigation. In step S14, the person desiring to invest in the project judges whether the person should invest in the project on the basis of the result of the investigation received from the trustee 3. When it is determined to invest in the project, the person desiring to invest in the project concludes an investment contract in step S15 and makes the investment in step S16 to become the investor 2. Thereafter, the project holder 1 and the investor 2 pay commissions to the trustee 3, respectively. The project holder 1 entrusts the trustee 3 with the components of the project. The investor 2 deposits a contribution with the trustee 3 and entrusts the trustee 3 with management of the contribution. On the other hand, when it is determined in step S14 not to make the investment, the processing proceeds to step S17 and an investment contract is not materialized.

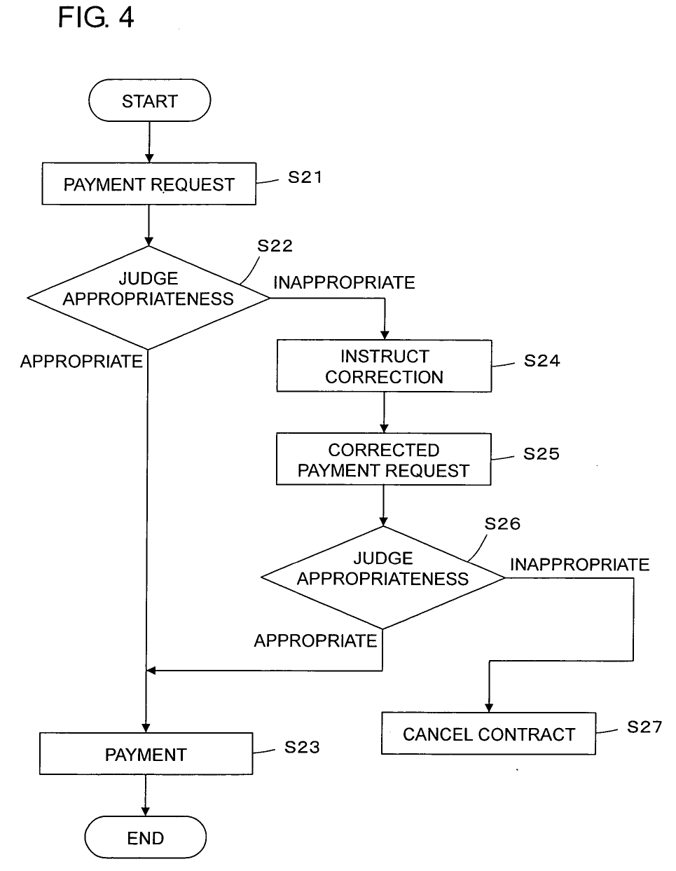

The contribution deposited as described above is paid according to an object and means predetermined between the project holder 1 and the trustee 3 or the investor 2. Processing for the payment request will be explained with reference to a flowchart in FIG. 4. First, when a payment request is received in step S21, the audit agency 4 judges appropriateness of the payment request in step S22 in view of the content of the payment request. When it is judged that the payment request is appropriate, the audit agency 4 sends a notification to that effect to the trustee 3. In step S23, a contribution is paid to the project holder 1 on the basis of the payment management program 32 of the trustee 3.

On the other hand, when it is judged instep S22 that the payment request is inappropriate and required to be corrected, the audit agency 4 sends a notification to that effect to the trustee 3. In step S24, the trustee 3 instructs the project holder 1 to correct the payment request. In step S25, the project holder 1, which has received the instruction, sends again a corrected payment request to the audit agency 4. In step S26, the audit agency 4 judges appropriateness of the newly-sent payment request. As a result of the judgment, if the payment request is appropriate, the procedure proceeds to step S23 and the contribution is paid to the project holder 1 on the basis of the payment management program 32 of the trustee 3. On the other hand, if the payment request is still inappropriate and required to be further corrected, the investment contract is cancelled in step S27.

It is also possible to cancel the investment contract when the payment request is inappropriate for the predetermined number of times equal to or more than three times, rather than canceling the investment contract again immediately when the payment request of the second time is inappropriate.

Project activities are performed by the project owner 11 or the project director 12. Payment of sales, a loyalty, or an agency contract deposit, which is a result of the project activities, is received by the project owner 11 or the project director 12. An amount of a predetermined rate is paid to the trustee 3. Alternatively, the payment is directly made to the trustee 3 first, and then, an amount of a predetermined rate is paid to the project owner 11 or the project director 12. This is recorded and managed in the fund management file 36 of the computer system of the trustee 3.

When such a payment is directly made to the trustee 3, the trustee 3 can pay predetermined current expenses, other expenses, and expenditures. In this case, it is possible to add a program for managing execution of such payment to the payment management program 32. Information recorded in the fund management file 36 is inputted to the payment management program 32. The money left after the end of payment processing of money obtained by the project activities is inputted and recorded as a dividend reserve in the dividend management program 33 to be described later.

Note that, in a case where sales, a loyalty, or an agency contract deposit is received first by the project holder 1, and then, an amount of the predetermined rate is paid to the trustee 3, the amount is inputted and recorded as the dividend reserve in the dividend management program 33 in the same manner.

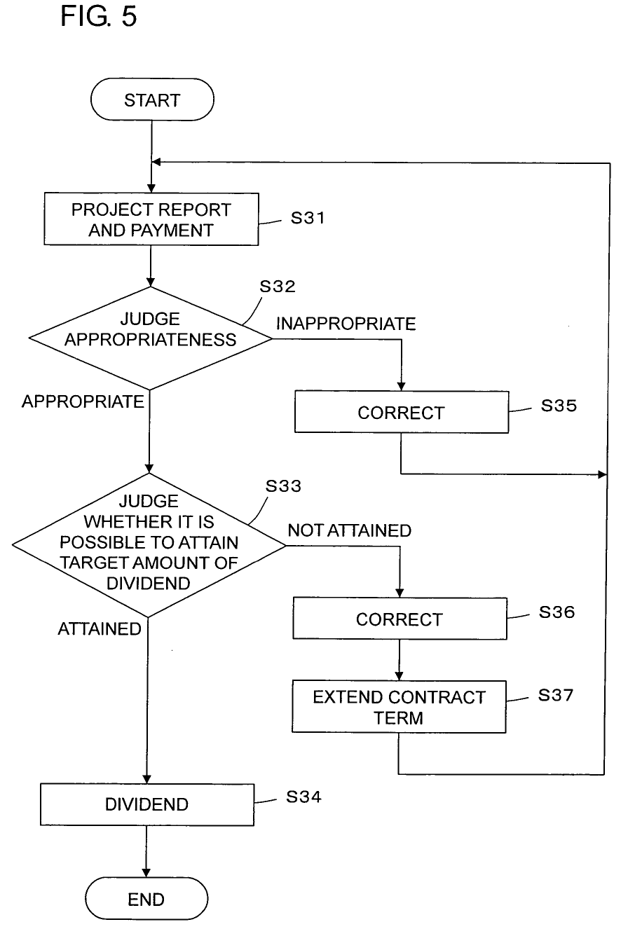

As investment recovery, a principal is recovered and a profit of the investment is acquired on the basis of dividend that is calculated and executed by the dividend management program 33. Processing for investment recovery will be explained with reference to a flowchart in FIG. 5. First, in step S31, the project holder 1 submits a project report and makes payment. Then, in step S32, the audit agency 4 judges whether a paid amount is appropriate in light of a state of progress of project. When it is judged that the paid amount is appropriate, the processing proceeds to step S33 and the audit agency 4 judges whether it is possible to attain a target dividend amount in light of a state of progress of the project. When the audit agency 4 judges that it is possible to attain the target dividend amount, in step S34, dividends are paid to both of the project holder 1 and the investor 2 by the computer system in accordance with the dividend management program 33. A result of the payment of the dividends is recorded in the dividend management file 37.

However, when it is judged in step S32 that the paid amount is not appropriate, in step S35, investment recovery management is performed on the basis of the first dividend management correction program 34a of the trustee 3. In some cases, steps S31, S32, and S35 are repeated, and then, the processing proceeds to step S33.

Similarly, when it is judged in step S33 that it is impossible to attain the target amount of a dividend, in step S36, investment recovery management is performed on the basis of the second dividend management correction program 34b. In addition, in step S37, a contract term of the investor 2 is extended and other investment recovery conditions are changed.

In this way, the investment contract ends at a point when a principal of the investment is recovered and a target profit is acquired within a predetermined target period. However, in a case where the recovery of the principal and the acquisition of the target profit are not attained within the target period or in a case where it is feared at a point of an interim dividend that the recovery of the principal and the acquisition of the target profit are not to be attained, the contract term is automatically extended, and it is possible to improve a target rate of return according to a system that is predetermined on the assumption of those cases. Calculation of a dividend, processing for payment of the dividend from a dividend reserve, and processing in a case in which targets are not attained, according to the predetermined system, are performed by the second dividend management correction program 34b provided in the computer system.

Note that, in some cases, it is also possible to constitute the first dividend management correction program 34a and the second dividend management correction program 34b as a single correction program in common.

As explained above, according to the present invention, it is possible to invest in a particular promising project independently from a project holder. Therefore, it is possible to develop a promising project without being affected by a managing status of the project holder and improve an investment result. Moreover, it is possible to realize objectivity and rapidity of investment management.

1. A system for managing project investment, characterized by comprising:
a project holder that has a particular project;
an investor that invests in the particular project; and
a trustee that is entrusted with components of the particular project by the project holder and performs investment recovery management using a computer based on a dividend management program agreed upon in advance between the project holder and the investor.

2. A system according to claim 1, wherein
the trustee investigates the components of the project entrusted by the project holder and notifies the investor of a result of the investigation, and
the investor determines investment in the particular project based on the result of the investigation notified by the trustee.

3. A system according to claim 1, further comprising an audit agency that audits progress of the project by the project holder.

4. A system according to claim 3, wherein
when a payment request is sent from the project holder, the audit agency judges whether it is necessary to correct the payment request, and
when it is judged that it is necessary to correct the payment request, the trustee instructs the project holder to correct the payment request, and, when it is judged that it is unnecessary to correct the payment request, the trustee executes payment to the project holder.

5. A system according to claim 3, wherein
when payment is made to the trustee from the project holder, the audit agency judges whether a paid amount is appropriate in light of a state of progress of the project, and
when it is judged by the audit agency that the paid amount is not appropriate, the trustee performs investment recovery management in accordance with a predetermined first dividend management correction program.

6. A system according to claim 3, wherein
the audit agency judges whether it is possible to attain a target dividend amount in light of a state of progress of the project, and
when it is judged by the audit agency that it is impossible to attain the target dividend amount, the trustee extends a contract term of the investor and performs investment recovery management in accordance with a predetermined second dividend management correction program.
